(19) United States
(12) Patent Application Publication
(10) Pub. No.: US 2025/0354589 A1
(43) Pub. Date: Nov. 20, 2025

(54) ELECTROMECHANICAL BRAKE DEVICE WITH ROTATION-TRANSLATION CONVERTER OF SHORT CONSTRUCTION

(71) Applicant: Continental Automotive Technologies GmbH, Hannover (DE)

(72) Inventors: Dirk Pauly, Frankfurt am Main (DE); I-Che Chiang, Frankfurt am Main (DE); Mathias Haag, Darmstadt (DE)

(73) Assignee: Continental Automotive Technologies GmbH, Hannover (DE)

(21) Appl. No.: 19/207,380

(22) Filed: May 14, 2025

(30) Foreign Application Priority Data
May 16, 2024 (DE) 10 2024 204 551.9

(51) Int. Cl. F16D 65/18; F16D 65/00; F16D 65/38; F16D 121/24; F16D 125/36; F16D 125/40; F16D 127/06

(52) U.S. Cl. CPC F16D 65/18; F16D 65/0068; F16D 2065/386; F16D 2121/24; F16D 2125/36; F16D 2125/40; F16D 2127/06

(57) ABSTRACT

An electromechanical brake device has a rotation-translation converter of short construction for moving a brake piston in an electromechanically operable wheel brake of a motor vehicle, and to a motor vehicle having an electromechanical brake device of this type. The electromechanical brake device comprises a caliper housing defining an actuator receptacle, an actuator unit having a piston movable in a linear manner relative to the caliper housing, wherein at least a portion of the actuator unit is arranged within the actuator receptacle, a drive unit to generate a drive torque which can be transmitted to the actuator unit, a rotation-translation converter of the actuator to axially shift the piston based on the drive torque; and at least one first rotation prevention device for securing against relative rotation between the piston and the actuator receptacle.

### TECHNICAL FIELD

The embodiments generally relate to an electromechanical brake device having a rotation-translation converter for moving a brake piston in an electromechanically operable wheel brake of a motor vehicle, and to a motor vehicle having an electromechanical brake device of this type.

### BACKGROUND

Electromechanical wheel brakes (“EMB”) are now used in modern motor vehicles and are increasingly also used as service brakes. These wheel brakes afford a number of differences to conventional, hydraulically actuated wheel brakes. For example, there is no longer need for a complex hydraulics system, and an electromechanical wheel brake also takes up significantly less space.

Electromechanical wheel brakes of this kind typically have an electronic drive unit, which interacts with a mechanism or a gear mechanism. A brake unit can then be arranged on the output side which, for example, may comprise a brake piston and a friction lining and which can be pressed against one another by means of a translational movement. It is thereby possible to bring about deceleration during operation.

To this end, the drive unit typically comprises at least one electric motor which has a correspondingly high power density. The mechanical connection to the friction brake can then be established by means of at least the gear mechanism. In addition to factors such as efficiency and rigidity, e.g. the mechanical design, the installation space requirements and the transmission characteristic curve determine the possible applications of the wheel brake.

Appropriate mechanisms are known for converting the rotational movement of the electric motor to the required translational or linear movement. A known mechanism is, for example, a rotation-translation converter comprising a so-called ramp mechanism or a ramp unit. A mechanism of this type is known, for example, from document DE 199 22 333 A1 held by the applicant. Although such mechanisms in conjunction with electromechanical wheel brakes can offer various benefits, for example a non-linear force displacement or the application of large axial forces, there are also difficulties. For instance, wear of the heavily stressed components, such as the friction partner, is detrimental, which means that appropriate wear compensation must be provided.

An alternative mechanism can therefore be seen in ball screw drives. These do not offer the option of non-linear power transmission. On the other hand, however, expensive wear compensation does not need to be provided, as the effective stroke may be longer than with rotation-translation converters with a ramp mechanism.

Known electromechanical brake devices with a ball screw drive as rotation-translation converter are therefore of relatively long construction in order to cover comparatively longer displacements, also with regard to wear compensation, which may be unfavorable with regard to the installation situation and the space requirement.

Therefore, an electromechanical brake device, with a ball screw drive, which at least mitigates or ideally does not exhibit the aforementioned difficulties is desirable.

The electromechanical brake device should be both compact in design and easy to manufacture. In addition, the greatest possible modularity in the design and in the individual components is also desired, as well as ease of assembly of the individual components and component parts.

### SUMMARY

An electromechanical brake device, in particular for a motor vehicle, comprises:
a caliper housing having an actuator receptacle,
an actuator unit having a piston arranged so as to be movable in a linear manner relative to the caliper housing, and
a drive unit,
wherein at least a portion of the actuator unit is arranged within the actuator receptacle,
wherein the drive unit is designed to generate a drive torque which can be transmitted to the actuator unit,
wherein the actuator unit comprises a rotation-translation converter which is designed to axially shift the piston based on the drive torque, and
wherein the piston comprises at least one first twist prevention means for securing against twisting relative to the actuator receptacle.

A motor vehicle may refer to a vehicle having axles, wherein at least one of these axles can comprise steerably guided wheels and, furthermore, the driving of the wheels on at least one axle can be adapted in a wheel-specific manner.

The electromechanically operable wheel brakes may be designed as electromechanical disk brakes (e-caliper), specifically for both front and rear axle applications in motor vehicles.

The electromechanical brake device may comprise the functions clearance setting, effective stroke for the service brake, parking brake locking and/or wear adjustment, wherein all functions may be included. Since no additional or separate components are required for the service brake and wear readjustment functions and both functions can be realized by a specific configuration of the rotation-translation converter, which is discussed in more detail below, wherein the number of components and component parts can also be minimized.

The configuration of an electromechanical brake device described below is shown purely as an example using an electromechanical disk brake for setting defined brake application forces. A transfer to an electromechanical drum brake for setting defined spreading forces or brake torques is easily possible for the skilled person.

The electromechanical disk brakes (e-calipers) may be designed in such a way that a brake application force can be produced by means of the electric motor, a front-mounted gear mechanism and a rotation-translation converter. The brake application force in this case refers to the force with which the brake pads are pressed against the brake disk, then produces a corresponding braking torque at the wheel in question. Depending on the embodiment and closed-loop control concept, the actuation of the electromechanical disk brakes can be designed in such a way that either a specified, defined clamping force or a specified, defined braking torque can be set in accordance with the deceleration demand requested.

The electromechanically operable drum brakes (e-drum) may be designed so that a motor/gear mechanism unit actuates an expansion module which presses the brake linings against the brake drum with an expansion force determined on the basis of the desired deceleration requested and thus produces a corresponding braking torque.

The caliper housing of the electromechanical brake device can be designed based on common designs for disk brake housings, for example for a floating caliper brake or for a first caliper brake. The caliper housing may also be designed here as a multi-piston unit or multi-piston caliper and comprise more than one actuator unit, for example two actuator units, wherein suitable actuator receptacles can be provided on the caliper housing accordingly. In this way, the caliper housing can be designed, for example, as a two-piston first caliper. The caliper housing may include appropriate mounts for securing friction linings for the implementation of a disk brake.

The actuator receptacle of the caliper housing may be designed for receiving and/or holding the actuator unit. For this purpose, the actuator receptacle may comprise a substantially cylindrical portion in which at least a portion of the actuator unit may be arranged. According to an embodiment, the caliper housing and the actuator receptacle may be formed in one piece and/or monolithically. Suitable materials may include, for example, a casting material.

The drive unit can comprise an electric motor, for example an electric motor for operating the electromechanical brake device as a constituent part of a motor vehicle brake of a motor vehicle. The drive unit can therefore be designed to generate a drive torque which can be transmitted to the actuator unit. Suitable gear mechanisms may be provided for power transmission, for example spur gear or planetary gear mechanisms. The gear mechanism may also be integrated into the drive unit.

The actuator unit may comprise a rotation-translation converter which is designed to shift the piston in an axial movement relative to the caliper housing based on the drive torque. A spindle, to which the drive torque can be transferred, and a threaded nut may be provided for conversion into an axial movement. In this way, friction linings can be moved and pressed against a brake disk to generate a predetermined brake torque.

According to an embodiment, the piston may comprise at least one first twist prevention means which can prevent twisting relative to the actuator receptacle. For this purpose, the first twist prevention means may comprise a projection protruding radially relative to the outer surface of the piston. The actuator receptacle may comprise at least one axially oriented groove or slot on the inner surface, facing toward the actuator unit or the piston, which groove or slot is of precisely mating design with respect to said projection. The projection can thus engage and be accommodated in said slot so that, with an axial movement of the piston, the piston can be guided axially while twisting can be prevented at the same time. According to another embodiment, the first twist prevention means may also comprise a recess in the region of the outer surface of the piston, in which a correspondingly designed projection of the actuator receptacle can then engage.

In order to be able to be guided accordingly over the entire distance of the effective stroke, according to an embodiment, provision is made for the first twist prevention means of the piston, for example the at least one projection, to be formed in the region of the portion of the piston facing toward the drive unit, e.g. in the region of the end-face end of the piston, and may be formed as part of the end face of the piston.

For a stable design of the electromechanical brake device, provision may be made for the piston and the actuator receptacle to comprise two or three such first twist prevention means in order to be able to safely counteract tilting during an axial movement.

According to an embodiment, the rotation-translation converter may be in the form of a ball screw drive or recirculating ball spindle. In principle, other designs are also conceivable, such as a screw/threaded drive. However, a ball screw drive is considered to be less expensive due to less wear and less friction. There is also a significant reduction in static friction. Compared to a ball-ramp mechanism as a rotation-translation converter, a ball screw drive offers the benefit that a readjustment mechanism with corresponding component parts provided for this can be omitted since, in a suitable design, readjustment can be achieved by a corresponding displacement of the piston relative to the caliper housing, for example to compensate for wear of the friction linings.

The ball screw drive may comprise a spindle having at least one helical groove with a semicircular cross section. The threaded nut may also be formed with at least one helical groove with a semicircular cross section. Both grooves can be of precisely mating or mutually corresponding design with respect to one another in a known manner. The tube formed as a result can be filled with balls, which can enable a corresponding force transmission. The portion of the spindle comprising the screw thread or the helical groove is hereinafter also referred to as the threaded portion and the adjacent portion, which establishes the connection to the drive unit, also referred to as the drive portion.

The threaded nut can be protected against twisting with respect to the piston by means of a second twist prevention means. For this purpose, the threaded nut may comprise, for example, an axial recess in which a correspondingly formed projection on the inner surface of the piston can engage. According to another embodiment, the threaded nut may also comprise a projection and the piston may comprise a recess of precisely mating design. Provision may also be made for the piston and the threaded nut to comprise at least two or three such second twist prevention means in order to be able to safely counteract tilting during a movement.

According to an embodiment, the actuator unit may further comprise a stop washer having at least one radially protruding lug which may be arranged at the transition between the threaded portion and the drive portion of the spindle. Furthermore, the threaded nut may comprise at least one axially protruding stop. The stop and the lug may be arranged with respect to one another in such a way that, in the retracted position of the piston, that is to say in its end position, the stop and the lug are engaged, so that in a way at the end of a backward-directed rotational movement the lug strikes the stop and thus enables a precise angular stop of the spindle. Overtightening can be prevented in this way.

According to an embodiment, the actuator receptacle may comprise on the end face facing toward the drive unit a base which has a substantially radial orientation and which may comprise a central passage hole for feeding through the drive portion of the spindle. The base may be designed to support the actuator unit or the rotation-translation converter and in this way absorb axial forces that arise during brake application.

According to another embodiment, provision may be made for the actuator receptacle to be formed as open on the end face facing toward the drive unit, which defines an opening. This opening may be designed in such a way that the actuator unit can be pushed through it for the purpose of assembly, for example. The opening therefore has a size that allows at least the piston to be pushed through it as the outer or largest part of the actuator unit. In this way, the assembly can be significantly simplified or made significantly more flexible.

The opening can be closed by a cover ring, wherein the cover ring comprises a central passage hole for feeding through the drive portion of the spindle. The cover ring may be designed and held here in such a way that it can fully absorb the axial forces that may arise when the brake application forces are applied by the actuator unit or the rotational-translation converter.

According to an embodiment, the cover ring can be protected against twisting relative to the caliper housing by means of at least one third twist prevention means. The third twist prevention means may comprise, for example, a radially protruding attachment piece which can engage in a recess of the caliper housing which is of precisely mating design.

In order to achieve a compact design, provision is made according to a embodiment for the threaded portion of the spindle to be able to be fully retracted into the cavity of the piston when the actuator unit is in the end position or in the retracted position. In other words, in this position or in the end position, the threaded portion can be located fully within the piston. Provision may be made for the piston to protrude only slightly over the threaded portion in an axial extent in order to reduce the installation length. In this way, a ratio of the axial extent of the piston L_{K} to the axial extent of the threaded portion L_{G} can be achieved, where the following holds true: L_{K}≤1.7*L_{G}, e.g. L_{K}≤1.5*L_{G} rather L_{K}≤1.3*L_{G} or L_{K}≤1.2*L_{G}, or L_{K}≤1.1*L_{G}.

In such a design, the piston may have an expansion in the axial direction approximately corresponding to its outer diameter.

The threaded nut may be designed and arranged in such a way that it can be received fully in the space resulting between the threaded portion of the spindle and the piston and, for example, does not protrude from the piston. This can also have an effect on the installation length of the actuator unit.

When the threaded portion is rotated, the threaded nut can be moved in a translational manner, thus applying the desired stroke in order to move the piston axially. The contact surfaces between the threaded nut and the piston may in this case be formed at an angle to the axis of rotation of the spindle, with the angle being between approximately 45° and approximately 90°. The contact surfaces, for example the contact surface of the threaded nut, may be of slightly spherical design in order to still ensure a sufficiently large and stable contact surface even in the event of slight deformations, such as a bending of the caliper housing, for example at high brake application forces.

According to a development, provision may be made for the actuator unit to comprise at least one sensor. This may be, for example, a force sensor designed to absorb a pressure. In this way, the contact pressure of the piston or the brake application force of the friction partners on one another can be determined. The at least one sensor can be arranged between the piston and the base or between the piston and the cover ring.

According to another development, provision may be made for an open-loop and closed-loop control unit (“WCU”=“wheel control unit”) for actuating the wheel brake or the drive unit to already be integrated in the drive unit. In this way, a very compact drive/open-loop control unit can be provided, which can easily be fixedly connected to the caliper housing of the electromechanical brake device by means of known securing means, such as screw connections. The drive/open-loop control unit as well as the caliper housing can thus be modularly preconfigured for the intended uses and combined differently with one another, which can permit a large range of possible variants of the electromechanical brake device and thus a high flexibility and ease of assembly.

The embodiments also includes a method for operating an electromechanical brake device as described above. The method may make provision for the spindle to be turned counter-clockwise together with the stop washer when operated. Since the spindle is supported axially in an axial bearing, the threaded nut secured against twisting with respect to the piston can be moved axially in the direction of the piston-side friction lining. This allows a brake application force to be generated on the brake disk by the reaction force on the friction lining on the first side. The piston, in turn, is secured against twisting with respect to the caliper housing.

For release, the spindle can be turned clockwise until the brake application force is fully reduced again. To prevent the spindle from being screwed too far into the threaded nut, the stop is located on the threaded nut against which the radially protruding lug of the stop washer rotates. Lining and disk wear can be adjusted or readjusted over the length of the spindle.

The embodiments also include here a motor vehicle comprising at least one electromechanical brake device as described above.

Further details of the invention are evident from the description of the illustrated exemplary embodiments and the attached claims.

### BRIEF DESCRIPTION OF THE DRAWINGS

In the drawings:

FIG. 1 shows a representation of an exemplary electromechanical brake device in longitudinal section with new friction linings,

FIG. 2 shows a further representation of the exemplary electromechanical brake device in longitudinal section from FIG. 1 with worn friction linings and readjusted spindle,

FIG. 3 shows a representation of a further exemplary electromechanical brake device in longitudinal section with new friction linings,

FIG. 4 shows a further representation of the further exemplary electromechanical brake device in the longitudinal section of FIG. 3 with worn friction linings and readjusted spindle,

FIG. 5 shows a rear view with some components on a caliper housing,

FIG. 6 shows a lateral top view of a caliper housing with actuator unit and cover ring in a kind of exploded view,

FIG. 7 shows an exploded view of the electromechanical brake device from FIG. 1,

FIG. 8 shows an exploded view of the electromechanical brake device from

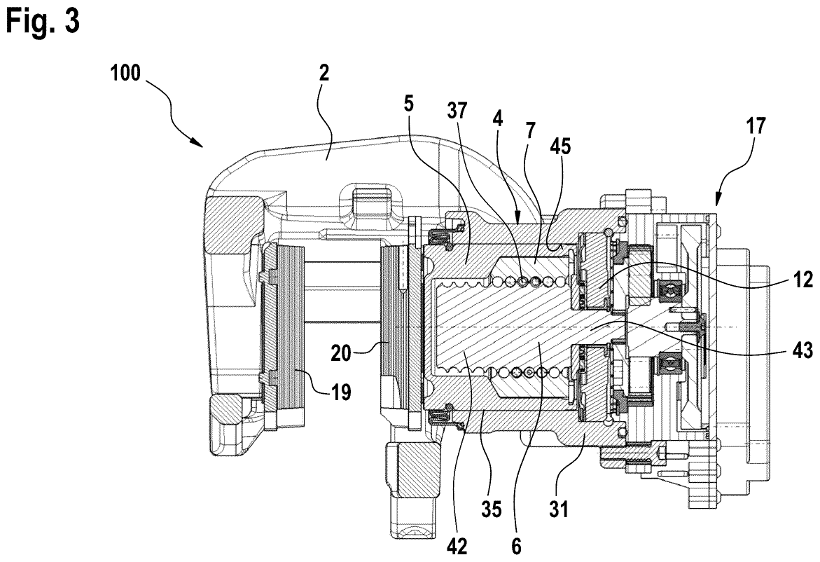

FIG. 3,

FIG. 9 shows an exploded view of an actuator unit,

FIG. 10 shows a top view of an exemplary electromechanical brake device,

FIG. 11 shows a further top view of an exemplary electromechanical brake device, and

FIG. 12 shows a further top view of an exemplary electromechanical brake device.

### DETAILED DESCRIPTION

In the following detailed description of embodiments, for the sake of clarity, the same reference signs designate substantially identical parts in or on these embodiments. However, for better clarification, the embodiments illustrated in the figures are not always drawn to scale.

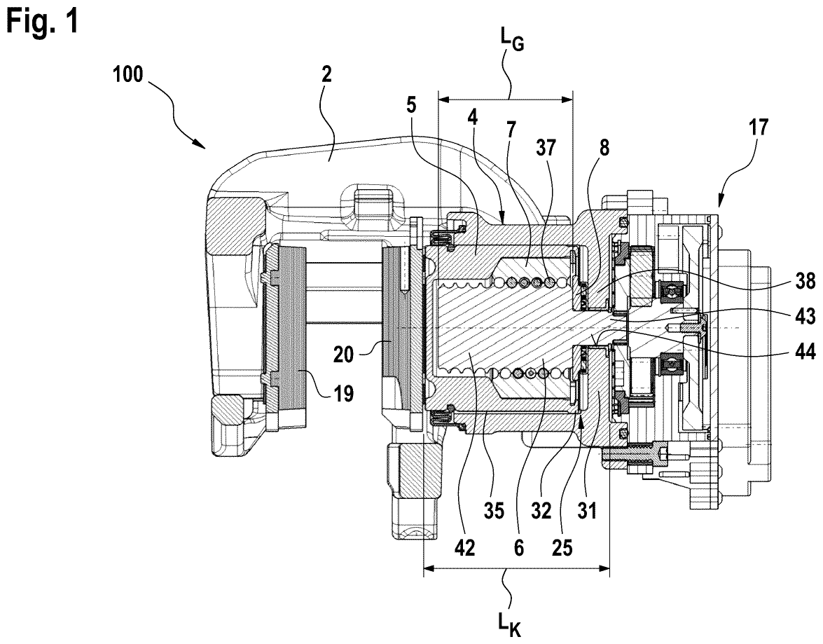

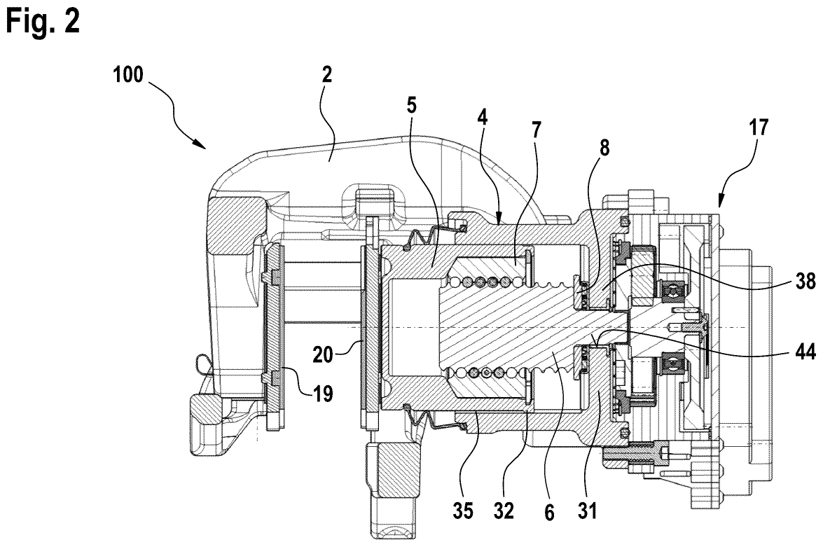

FIG. 1 shows a representation of an exemplary electromechanical brake device 100 in longitudinal section with new friction linings 19, 20, and FIG. 2 shows a further representation of the exemplary electromechanical brake device 100 in longitudinal section from FIG. 1 with worn friction linings 19, 20 and a readjusted spindle 6. For reasons of clarity, only those elements of the electromechanical brake device 100 which are relevant to the embodiment of the approach are illustrated here.

The electromechanical brake device 100 is suitable for a motor vehicle and comprises:
a caliper housing 2 having an actuator receptacle 31,
an actuator unit 4 having a piston 5 arranged so as to be movable in a linear manner relative to the caliper housing 2, and
a drive unit 17,
wherein at least a portion of the actuator unit 4 is arranged within the actuator receptacle 31,
wherein the drive unit 17 is designed to generate a drive torque which can be transmitted to the actuator unit 4,
wherein the actuator unit 4 comprises a rotation-translation converter which is designed to axially shift the piston 5 based on the drive torque, and
wherein the piston 5 comprises at least one first twist prevention means 25 for securing against twisting relative to the actuator receptacle 31.

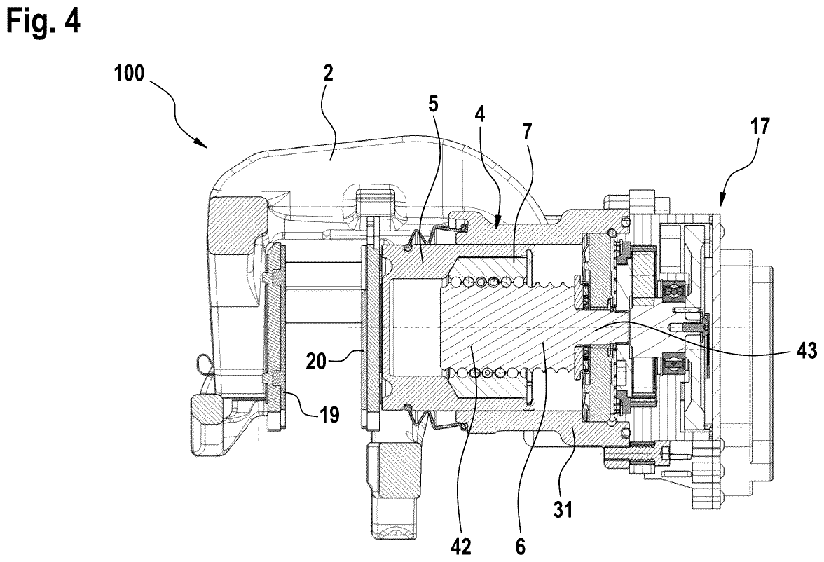

FIG. 3 shows a representation of a further exemplary electromechanical brake device 100 in longitudinal section with new friction linings 19, 20, and FIG. 4 shows a further representation of the further exemplary electromechanical brake device 100 in longitudinal section from FIG. 3 with worn friction linings 19, 20 and a readjusted spindle 6. These designs, which show an alternative embodiment of the caliper housing 2, will be discussed in more detail below.

The embodiments and configurations of the electromechanical brake device 100 described relate purely by way of example to electromechanical disk brakes for setting defined brake application forces. A transfer to an electromechanical drum brake for setting defined spreading forces or braking torques is therefore possible and not excluded. The electromechanical brake device 100 can be used both for wheel brakes on the front and/or rear axles of motor vehicles.

The electromechanical brake device 100 comprises the functions of clearance setting, effective stroke for the service brake, parking brake locking and/or wear adjustment.

The parking brake locking is integrated into the drive unit 17. This locking may include a lock that can prevent rotation so that no torque can be transmitted to or from the rotation-translation converter.

The service brake and wear readjustment functions are implemented by the design of the components or the rotation-translation converter so as to produce a simple and easy-to-assemble design.

The electromechanical brake device 100 illustrated by way of example is designed in such a way that a brake application force can be produced by means of an electric motor, a front-mounted gear mechanism and a rotation-translation converter. The electric motor and the front-mounted gear mechanism are integrated into the drive unit 17.

If the friction linings 19, 20 are pressed against the brake disk (not shown), a corresponding brake torque can be applied to the wheel in question. For the realization of the electromechanical brake device 100 as electromechanically operable drum brakes, provision may be made of a spreading module which presses the brake pads against the brake drum with a predefined spreading force and in this way generates a corresponding brake torque.

The caliper housing 2 of the electromechanical brake device 100 is designed as a first caliper brake. Other possible designs may include a floating caliper brake or a multi-piston unit, for example as a two-piston first caliper.

In the exemplary embodiment, the caliper housing 2 further comprises a caliper mount 1 for mounting and securing the friction linings 19, 20.

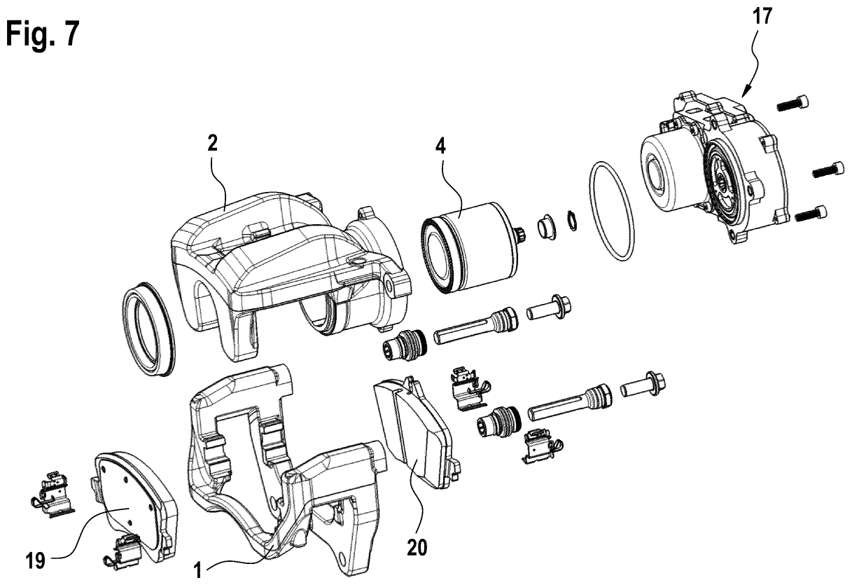

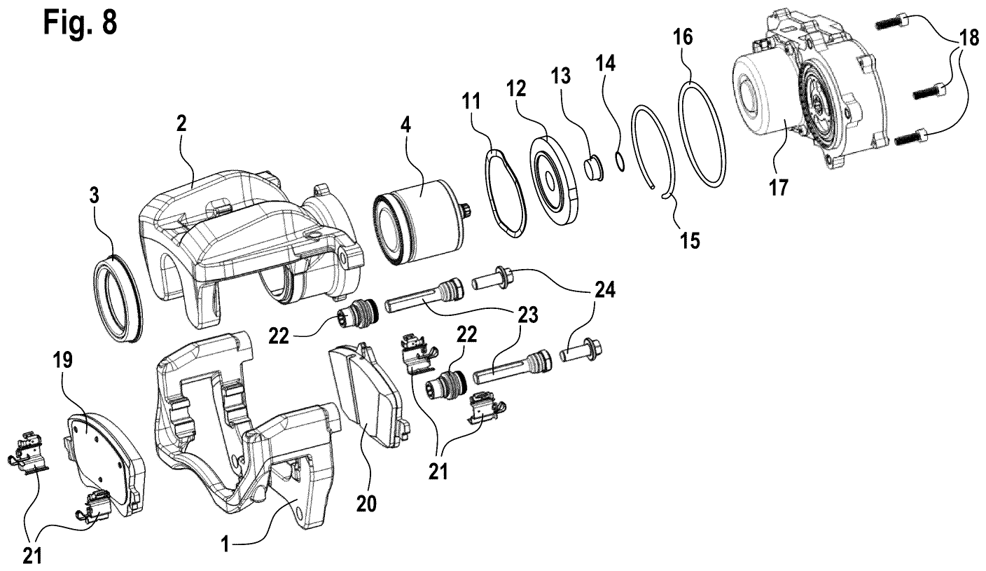

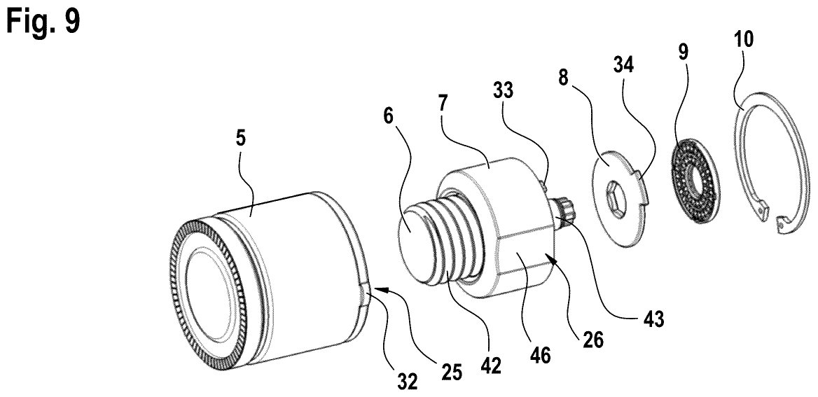

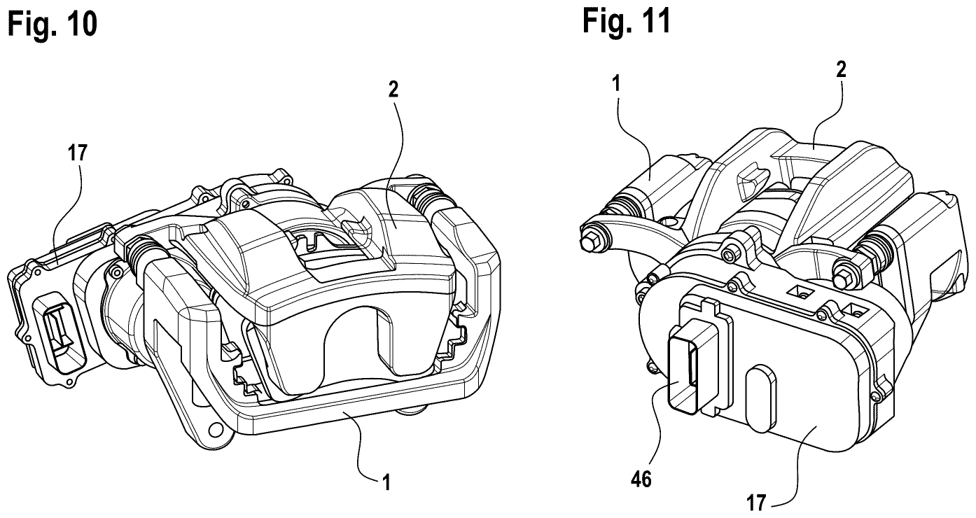

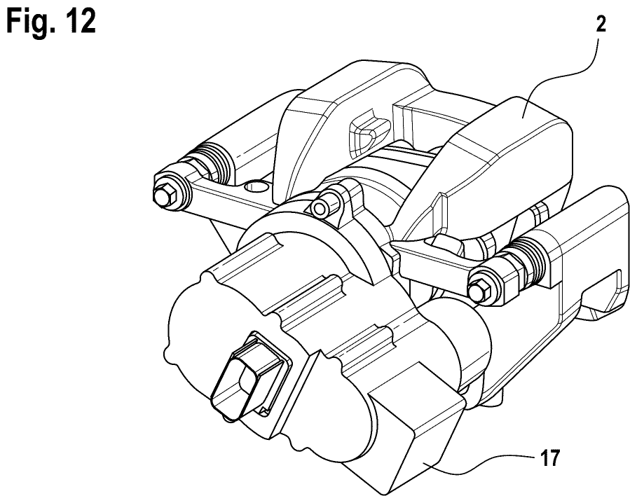

A possible configuration of a caliper mount 1 can be seen, for example, from FIG. 7 or 8. The securing means for holding the friction linings 19, 20 on the caliper mount 1 in the exemplary embodiment shown include mounts 21, folded bellows 22, guide pins 23 and screws 24.

The actuator receptacle 31 comprises a substantially cylindrical portion in which at least a portion of the actuator unit 4 is arranged. For example, in the embodiment shown, the threaded portion 42 of the spindle 6 remains within the actuator receptacle 31, even in the case of an axial movement of the piston 5. The piston 5 and the threaded nut 7, on the other hand, are axially movable and can therefore, as shown in FIGS. 2 and 4, be moved from the actuator receptacle 31, for example in the direction of the friction linings 19, 20.

In the embodiment shown, the caliper housing 2 and the actuator receptacle 31 are formed in one piece and monolithically, that is to say they are made of a single material. The material in the present case comprises a casting material, which enables cost-effective manufacture.

The drive unit 17 comprises the electric motor which is designed to generate a drive torque using which the spindle 6 can be supplied with a torque via a transmission gear during operation of the electromechanical break device 100. The drive portion 43 of the spindle 6 is therefore in operative connection with the transmission gear.

The rotation-translation converter of the actuator unit 4 is designed to move the piston 5 in an axial movement along its axis of rotation relative to the caliper housing 2 based on the drive torque of the drive unit 17. The threaded nut 7 is provided to transfer the force component to the piston 5. The piston 5 can thus press the friction linings 19, 20 against the brake disk to generate a predetermined brake torque or a predetermined brake application force.

The piston 5 comprises a first twist prevention means 25 for securing against axial twisting or rotation about the axis of rotation relative to the actuator unit 4. In the embodiment shown by way of example in FIG. 9, the piston 5 comprises a projection 32 protruding radially relative to the outer surface of the piston 5. The actuator receptacle 31 is formed on the inner surface, facing toward the actuator unit 4, having at least one axially oriented groove or slot 35 which is of precisely mating design with respect to said projection 32. The projection 32 can thus engage and be accommodated in said slot 35 so that, with an axial movement of the piston, the piston 5 can be reliably guided axially while twisting can be prevented at the same time.

In order to be able to be guided accordingly over the entire distance of the effective stroke, according to a embodiment, provision is made for the projection 32 of the piston 5 to be formed in the region of the portion of the piston 5 facing the drive unit, e.g. in the region of the end-face end of the piston 5, and to be for example formed as part of the end face of the piston 5.

According to another embodiment, not illustrated in more detail here, the first twist prevention means 25 may also comprise a recess on the outer surface of the piston 5, in which a correspondingly designed projection 32 of the actuator receptacle 31 can then engage.

For a stable design of the electromechanical brake device 100, provision is made for the piston 5 and the actuator receptacle 31 to comprise two or three such first twist prevention means 25. In this way, tilting during an axial movement can be reliably counteracted.

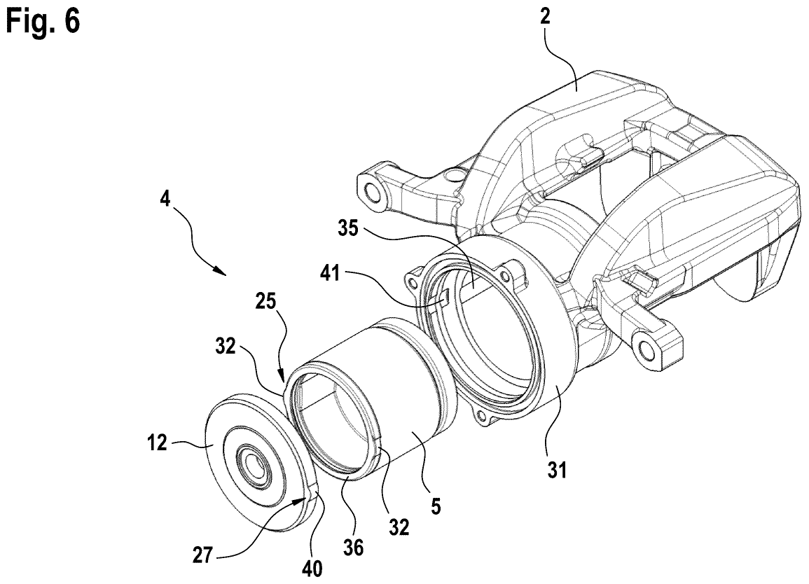

In FIG. 6, which shows a lateral plan view of the caliper housing 2 with an actuator unit 4 in a kind of exploded view, the piston 5 is formed with two oppositely arranged projections 32. These are designed as part of the drive-side end face of the piston. Portions of one of the two slots 35 can be seen on the inner surface of the actuator receptacle 31.

In the embodiments of the electromechanical brake device 100 shown in the figures, the rotation-translation converter is formed as a ball screw drive or recirculating ball spindle. In principle, other designs are also conceivable, such as a screw/threaded drive.

The ball screw drive comprises the spindle 6 which has a helical groove with an approximately semicircular cross section in a threaded portion 42. The threaded nut 7 is also formed with at least one helical groove with an approximately semicircular cross section. Both grooves are of precisely mating design so that balls 37 can move in the tube formed thereby, which balls enable the desired force transmission or conversion. The threaded portion 42 of the spindle 6 passes into the drive portion 43, which establishes the connection to the drive unit 17 and can be supplied with the drive torque. The drive portion 43 has a smaller cross-sectional surface than the threaded portion 42.

The threaded nut 7 comprises a second twist prevention means 26 against axial twisting or rotation about the axis of rotation relative to the piston 5. In the embodiment shown in FIG. 9, an axial recess 46 is provided for this purpose, in which recess a correspondingly formed projection on the inner surface of the piston 5 engages.

In the embodiments of the electromechanical brake device 100 shown in FIGS. 1 to 4, the actuator unit 4 comprises a stop washer 8. The stop washer 8 is arranged at the transition between the threaded portion 42 and the drive portion 43 of the spindle 6. In this case, the stop washer 8 is pushed onto the drive portion 43 and is held axially by the thread portion 42 protruding radially with respect to the drive portion 43 and an axial bearing 9. FIG. 9 shows in this respect an exploded view of the actuator unit 4 with the stop washer 8.

The stop washer 8 comprises a radially protruding lug 34. Furthermore, the threaded nut 7 comprises an axially protruding stop 33. The lug 34 and the stop 33 are arranged in such a way that, in the retracted position of the piston 5 or in the end position of the piston 5, the lug 34 strikes the stop 33. At the end of a braking operation, when the threaded nut 7 is rotated back into the end position by a corresponding backward-directed rotational movement of the spindle 6, a highly precise angular stop of the spindle 6 can thus be made possible. This can also prevent the spindle 6 from being overtightened.

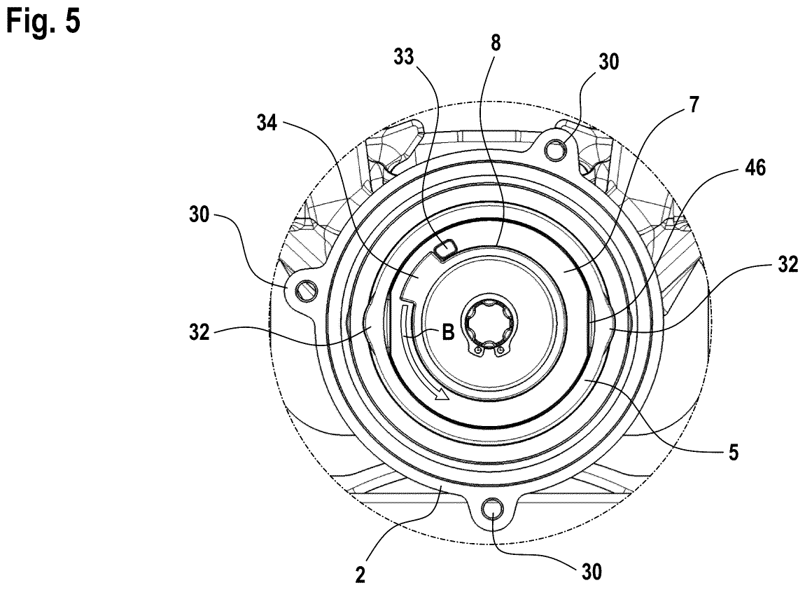

FIG. 5 shows a view of an open caliper housing 2 in the direction of the friction linings. For reasons of clarity, not all components are shown. Three securing points 30 used for easy assembly of the drive unit 17 can easily be seen in this view. The brake application direction is marked by the designation “B”. The position shown corresponds to the end position in which the lug 34 has struck the stop 33.

According to a embodiment of the electromechanical brake device 100, the actuator receptacle is formed on the end face facing toward the drive unit 17 having a base 38. As can be seen in FIGS. 1 and 2, this base 38 is oriented radially or perpendicularly to the stroke direction. Furthermore, it has a central passage hole 44 for feeding through the drive portion 43 of the spindle 6. Such an embodiment of the electromechanical brake device 100 is shown in FIGS. 1 and 2. The base 38 is used for the axial support of the actuator unit 4 or the rotation-translation converter.

According to another embodiment of the electromechanical brake device 100, the actuator receptacle 31 is formed to be open on the end face facing toward the drive unit 17. This defines an opening 45, which is dimensioned such that the actuator unit 17 can be pushed through it as a whole. As can be seen from FIG. 3 or 4, the opening 45 has a size that allows at least the piston 5 to be pushed through it as the outer or largest part of the actuator unit 17. Such an embodiment of the electromechanical brake device 100 is shown in FIGS. 3 and 4. In this way, the assembly, for example of the actuator unit 17 and the caliper housing 2, can be significantly simplified or made more flexible.

After inserting the actuator unit 17, the opening 45 is closed by a cover ring 12, wherein the cover ring 12 also comprises a central passage hole for feeding through the drive portion of the spindle 6. The cover ring 12 has a high rigidity, e.g. in the axial direction, so that it can receive the axial forces which can arise during application of the brake application forces by the actuator unit 4 or the rotation-translation converter and carry them away to the caliper housing 2. The cover ring 12 comprises at least one third twist prevention means 27 against axial twisting or rotation about the axis of rotation relative to the caliper housing 2. In the illustrated exemplary embodiment, a radially protruding attachment piece 40 is provided, which engages in a precisely mating recess 41 of the caliper housing 2 so as to bring about twist prevention.

FIG. 7 shows an exploded view of the electromechanical brake device 100 as shown in FIGS. 1 and 2. FIG. 8 shows a further exploded view of the electromechanical brake device 100 as shown in FIGS. 3 and 4.

It is easy to see that, in the embodiment with an actuator receptacle 31 with base 38, fewer components are required overall. The drive unit 17, also referred to as the engine transmission unit (ETU), is securely and releasably connected to the caliper housing 2 by means of suitable securing means, in the example using three cylinder screws 18. According to an embodiment of the electromechanical brake device 100, the associated securing points on the caliper housings 2 are arranged in the same way so that different combinations of drive unit 17 and brake device 100 can easily be implemented flexibly, wherein the caliper housing 2 and the drive unit 17 can be configured differently depending on the intended use, for example the drive unit 17 having a stronger or less powerful electric motor.

The present embodiments make it possible to achieve a compact design of the electromechanical brake device 100. To this end, provision is made for: the thread portion 42 of the spindle 6 to be able to be fully retracted into the cavity of the piston 6 when the actuator unit 4 is in the end position or in the retracted position. In other words, in this position or in the end position, the threaded portion 42 is located fully within the piston 5. This can be seen clearly in FIGS. 1 and 3, which show a piston 5 in the retracted position. In this case, the piston 5 only slightly projects beyond the threaded portion 42 in an axial extent. In this way, the installation length of the electromechanical brake device 100 can be reduced.

In this way, a ratio of the axial extent or length of the piston L_{K} to the axial extent of the threaded portion L_{G} can be achieved, where the following holds true: L_{K}≤ 1.7*L_{G}, for example L_{K}≤1.5*L_{G} e.g. L_{K}≤1.3*L_{G} or L_{K}≤1.2*L_{G}, or L_{K}≤1.1*L_{G}. In the embodiment shown in FIG. 1, the piston 5 projects beyond the threaded portion 42 by about 1.2 times. A very compact design is also possible in an orientation perpendicular to the central axis of the piston 5. In the embodiment shown in FIG. 1, the piston 5 has an extent in the axial direction, which approximately corresponds to its outer diameter.

The threaded nut 7 is fully accommodated in the space resulting between the threaded portion 42 of the spindle 6 and the piston 5, which also favorably influences the installation length of the actuator unit 4. When the spindle 6 is rotated, the threaded nut 7 is moved in a translational manner, as a result of which the desired stroke can be applied and the piston 5 is moved axially accordingly.

The contact surfaces between the threaded nut 7 and the piston 5 may in this case be formed at the same angle to the axis of rotation of the spindle, with the angle being between approximately 45° and approximately 90°. In the exemplary embodiments shown, the angle is >45%, approximately 60°, which enables greater axial forces to be transferred. The contact surfaces, for example the contact surface of the threaded nut, is of slightly spherical design in order to still ensure a sufficiently large and stable contact surface even in the event of slight deformations of the caliper housing.

According to a development, provision is made for the actuator unit 4 to comprise at least one sensor (not illustrated). This may be, for example, a force sensor designed to absorb a pressure. In this way, the contact pressure of the piston 5 or the brake application force of the friction partners on one another can be determined. The at least one sensor can be arranged between the piston 5 and the base 38 or between the piston 5 and the cover ring 12.

According to another development, provision is made for the functions required to actuate the electromechanical brake device 100 or the drive unit to be combined and integrated in the drive unit 17, at least predominantly, in a suitably designed open-loop and closed-loop control unit.

In this way, a very compact and flexibly applicable drive/open-loop control unit 17 can be provided, which can be easily connected to the caliper housing 2 of the electromechanical brake device 100. The drive/open-loop control unit as well as the caliper housing can thus be modularly preconfigured for the intended uses and combined with one another, which can permit a large range of possible variants of the electromechanical brake device 100.

FIGS. 10, 11 and 12 each show a top view of exemplary embodiments of the electromechanical brake device 100. The electromechanical brake devices 100 are designed as first caliper brakes and are optimized for different performance classes.

The method for operating the electromechanical brake device 100 makes provision for the spindle 6 to be turned counter-clockwise together with the stop washer when operated. Since the spindle 6 is supported axially on an axial bearing 9, the threaded nut 7 which is secured against twisting with respect to the piston 5 can be moved axially in the direction of the piston-side friction lining 19, 20. This allows a brake application force to be generated on the brake disk by the reaction force on the friction lining on the first side. The piston 5, in turn, is secured against twisting with respect to the caliper housing 2.

For release, the spindle 6 can be turned clockwise until the brake application force is fully reduced again. To prevent the spindle 6 from being screwed too far into the threaded nut 7, the stop 33 is located on the threaded nut 7 against which the radially protruding lug 34 of the stop washer 8 rotates. Lining and disk wear can be adjusted or readjusted over the length of the spindle 6.

The embodiments also include a motor vehicle comprising at least one electromechanical brake device 100 as described above.

1. An electromechanical brake device for a motor vehicle comprising:
a caliper housing defining an actuator receptacle;
an actuator unit having a piston movable in a linear manner relative to the caliper housing, wherein at least a portion of the actuator unit is arranged within the actuator receptacle;
a drive unit to generate a drive torque which can be transmitted to the actuator unit;
a rotation-translation converter of the actuator to axially shift the piston based on the drive torque; and
at least one first rotation prevention device for securing against relative rotation between the piston and the actuator receptacle.

2. The electromechanical brake device as claimed in claim 1, wherein the electromechanical brake device provides at least one of: clearance setting, effective stroke provision for the service brake, parking brake locking and wear adjustment.

3. The electromechanical brake device as claimed in claim 1, wherein the caliper housing is one of a floating caliper housing and first caliper housing.

4. The electromechanical brake device as claimed in claim 1, wherein the caliper housing and the actuator receptacle are formed in one piece with a casting material.

5. The electromechanical brake device as claimed in claim 1, wherein the first rotation prevention device further comprises:
at least one projection protruding radially relative to the outer surface of the piston; and
at least one axially oriented slot defined on the inner surface of the actuator receptacle;
wherein the at least one axially oriented slot has a mating design with respect to at least one of the receptacle and an axial guide of the projection.

6. The electromechanical brake device as claimed in claim 5, wherein the projection is formed in a region of a portion of the piston facing toward the drive unit, in the region of the end-face end of the piston and is formed as part of the end face of the piston.

7. The electromechanical brake device as claimed in claim 1, wherein the piston and the actuator receptacle comprise at least two or three first rotation prevention devices.

8. The electromechanical brake device as claimed in claim 1, wherein the rotation-translation converter is a ball screw drive, comprising a spindle, balls, and a threaded nut.

9. The electromechanical brake device as claimed in claim 1, wherein the threaded nut is protected against rotation with respect to the piston by at least one second rotation prevention device.

10. The electromechanical brake device as claimed in claim 1, wherein the actuator unit comprises a stop washer having at least one radially projecting lug.

11. The electromechanical brake device as claimed in claim 10, wherein the threaded nut comprises at least one axially protruding stop, wherein, in an end position, in the retracted position, the lug can strike against the stop.

12. The electromechanical brake device as claimed in claim 1, wherein the actuator receptacle comprises on the end face facing toward the drive unit a base which has a radial orientation and which comprises a central passage hole for feeding through a drive-side portion of the spindle.

13. The electromechanical brake device as claimed in claim 1, wherein the actuator receptacle is formed to be open on the end face facing toward the drive unit, which defines an opening, wherein the opening is dimensioned such that the actuator unit can be pushed through it.

14. The electromechanical brake device as claimed in claim 1, wherein the opening is closed by a cover ring, wherein the cover ring comprises a central passage hole for feeding through the drive portion of the spindle.

15. The electromechanical brake device as claimed in claim 1, wherein the cover ring is protected against twisting with respect to the caliper housing by at least one third twist prevention device.

16. The electromechanical brake device as claimed in claim 1, wherein the threaded portion of the spindle is arranged within the cavity of the piston, and wherein for the extent of the piston L_{K} with respect to the axial extent of the threaded portion: L_{K}≤1.7*L_{G}.

17. The electromechanical brake device as claimed in claim 1, wherein the actuator unit comprises at least one sensor on the side of the base or the cover ring facing toward the piston.

18. The electromechanical brake device as claimed in claim 1, wherein an open-loop and closed-loop control unit is provided for actuating the drive unit, wherein the open-loop and closed-loop control unit is integrated in the drive unit.

19. The electromechanical brake device as claimed in claim 1, wherein the electromechanical brake device is in a motor vehicle.
